(19) United States
(12) Patent Application Publication
(10) Pub. No.: US 2025/0385949 A1
(43) Pub. Date: Dec. 18, 2025

(54) APPLICATION REQUEST PROCESSING

(71) Applicant: Beijing Zitiao Network Technology Co., Ltd., Beijing (CN)

(72) Inventors: Yile Zhang, Beijing (CN); Bo Wang, Beijing (CN); Xudong Zhang, Beijing (CN); Wei Li, Beijing (CN)

(21) Appl. No.: 18/986,155

(22) Filed: Dec. 18, 2024

(30) Foreign Application Priority Data
Jun. 18, 2024 (CN) 202410789249.9

(51) Int. Cl. H04L 67/50

(52) U.S. Cl. CPC H04L 67/50

(57) ABSTRACT

Embodiments of the present disclosure relate to a request processing method, apparatus, device, and a storage medium. The method provided herein comprises: receiving a target request to be processed by a target application, the target application being associated with a plurality of processing entities; in response to the target request being provided to a first processing entity of the plurality of processing entities, generating evaluation information corresponding to the target request using a first model, the evaluation information indicating a matching degree between the first set of processing entities associated with the first processing entity and the target request; and in response to the evaluation information satisfying a predetermined condition, determining a first jump policy associated with the first processing entity using a second model. In this manner, embodiments of the present disclosure can improve the processing efficiency of requests.

### CROSS REFERENCE TO RELATED APPLICATIONS

This disclosure claims priority to Chinese Patent Application No. 202410789249.9, filed on Jun. 18, 2024 in the Chinese Intellectual Property Office and entitled “REQUEST PROCESSING METHOD, APPARATUS, DEVICE, AND STORAGE MEDIUM”, the disclosure of which is incorporated by reference herein in its entirety.

### FIELD

Example embodiments of the present disclosure generally relate to the field of computers, and more particularly, to request processing by a target application.

### BACKGROUND

With the development of computer technology, people may create and publish various types of applications through different platforms. For example, with the development of machine learning techniques, a user can quickly create applications by configuring parameters of the application, such as models used by the application, available plug-ins, and so on.

### SUMMARY

In a first aspect of the present disclosure, a request processing method is provided. The method comprises: receiving a target request to be processed by a target application, the target application being associated with a plurality of processing entities; in response to the target request being provided to a first processing entity of the plurality of processing entities, generating evaluation information corresponding to the target request using a first model, the evaluation information indicating a matching degree between the first set of processing entities associated with the first processing entity and the target request; and in response to the evaluation information satisfying a predetermined condition, determining a first jump policy associated with the first processing entity using a second model.

In a second aspect of the present disclosure, a request processing apparatus is provided. The apparatus comprises: a receiving module configured to receive a target request to be processed by a target application, the target application being associated with a plurality of processing entities; a generating module configured to, in response to the target request being provided to a first processing entity of the plurality of processing entities, generate evaluation information corresponding to the target request using a first model, the evaluation information indicating a matching degree between the first set of processing entities associated with the first processing entity and the target request; and a determining module configured to, in response to the evaluation information satisfying a predetermined condition, determine a first jump policy associated with the first processing entity using a second model.

In a third aspect of the present disclosure, there is provided an electronic device, the device comprising at least one processing unit; and at least one memory coupled to the at least one processing unit and storing instructions for execution by the at least one processing unit. The instructions, when executed by the at least one processing unit, cause the apparatus to perform the method of the first aspect.

In a fourth aspect of the present disclosure, a computer readable storage medium is provided, where the computer readable storage medium stores a computer program, and the computer program is executable by a processor to perform operations that implement the method of the first aspect.

It should be understood that the content described in this content section is not intended to limit the key features or important features of the embodiments of the present disclosure, nor is it intended to limit the scope of the present disclosure. Other features of the present disclosure will become readily understood from the following description.

### BRIEF DESCRIPTION OF THE DRAWINGS

The above and other features, advantages, and aspects of various embodiments of the present disclosure will become more apparent from the following detailed description taken in connection with the accompanying drawings. In the drawings, the same or similar reference numbers refer to the same or similar elements, wherein:

FIG. 1 illustrates a schematic diagram of an example environment.

FIG. 2 illustrates a flowchart of an example process of request processing.

FIG. 3A illustrates an example framework of a request processing system.

FIG. 3B illustrates an example framework of a policy decision unit.

FIG. 4 illustrates a schematic structural block diagram of an example request processing apparatus.

FIG. 5 illustrates a block diagram of an example electronic device capable of implementing various embodiments of the present disclosure.

### DETAILED DESCRIPTION

Embodiments of the present disclosure will be described in more detail below with reference to the accompanying drawings. Although certain embodiments of the present disclosure are shown in the accompanying drawings, it should be understood that the present disclosure may be implemented in various forms and should not be construed as limited to the embodiments set forth herein, but rather, these embodiments are provided for a thorough and complete understanding of the present disclosure. It should be understood that the drawings and embodiments of the present disclosure are only for illustrative purposes and are not intended to limit the scope of the present disclosure.

It should be noted that the headings of any section/subsection provided herein are not limiting. Various embodiments are described throughout herein, and any type of embodiment may be included under any section/subsection. Furthermore, embodiments described in any section/subsection may be combined in any manner with any other embodiments described in the same section/subsection and/or different sections/subsections.

In the description of the embodiments of the present disclosure, the term “including” and the like should be understood as open-ended including, that is, “including but not limited to”. The term “based on” should be read as “based at least in part on.” The term “one embodiment” or “the embodiment” should be read as “at least one embodiment.”. The term “some embodiments” should be understood as “at least some embodiments.” Other explicit and implicit definitions may also be included below. The terms “first”, “second”, etc. may refer to different or identical objects. Other explicit and implicit definitions may also be included below.

Embodiments of the present disclosure may relate to data of the user, acquisition and/or use of data, etc., and all these aspects follow respective legal regulations and related regulations. In embodiments of the present disclosure, all data collection, acquisition, processing, manufacturing, forwarding, use, and the like, are made with user knowledge and confirmation. Accordingly, when implementing the embodiments of the present disclosure, the user should be informed of the types, usage ranges, usage scenarios, and the like of data or information that may be involved, in an appropriate manner according to relevant legal regulations, and the authorization of the user is obtained. The specific informing and/or authorization manner may vary according to actual situations and application scenarios, and the scope of the present disclosure is not limited in this aspect.

In the present description and the embodiments, the personal information processing is performed on the basis of legitimacy (for example, the consent of the personal information body is obtained, or necessary for fulfillment of a contract, etc.), and is performed only within a regulated range or a promissory range. The user's rejection of the use of personal information other than the necessary information required for processing the basic function will not affect the use of the basic function by the user.

Conventionally, there are systems that support a user's configuration of a model, a plug-in, and the like to quickly create an application, for example, a bot program (bot). However, some applications may include a plurality of processing entities (e.g., sub-bots or agents). Thus, how to manage jumps between such processing entities has become a focus of interest.

Embodiments of the present disclosure provide a request processing solution. According to the solution, a target request to be processed can be received by a target application, and the target application is associated with a plurality of processing entities. Further, in response to a target request being provided to a first processing entity among the plurality of processing entities, evaluation information corresponding to the target request may be generated using the first model, the evaluation information indicating a matching degree between the first set of processing entities associated with the first processing entity and the target request. Correspondingly, a first jump policy associated with the first processing entity may be determined using the second model, in response to the evaluation information satisfying the predetermined condition.

In this manner, embodiments of the present disclosure can use a hybrid model (e.g., a model of various processing capabilities) to determine a jump policy for an in-application processing entity (e.g., a bot or an agent), thereby improving the processing efficiency of requests.

Various example implementations of the solution are described in further detail below with reference to the accompanying drawings.

### Example Environment

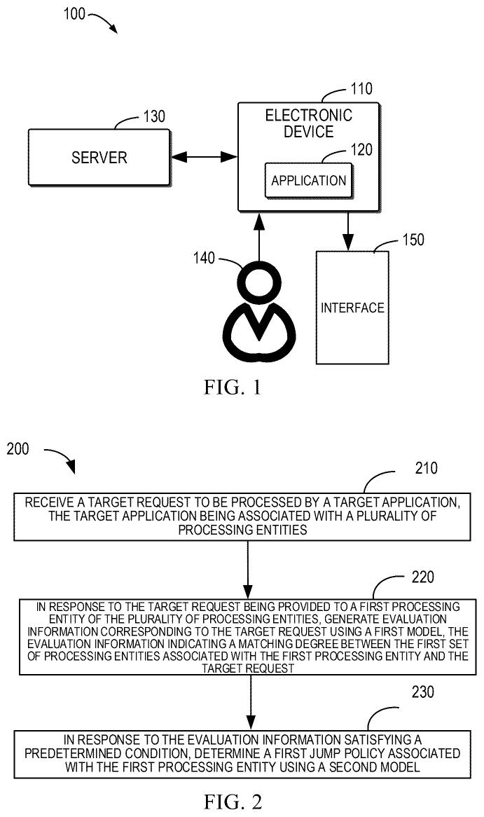

FIG. 1 shows a schematic diagram of an example environment 100 in which embodiments of the present disclosure can be implemented. As shown in FIG. 1, the example environment 100 can include an electronic device 110.

In this example environment 100, the electronic device 110 can be executed with an application 120 that supports interface interaction. The application 120 can be any suitable type of application for interface interaction, examples of which can include, but are not limited to, a development application or other suitable application that supports application development. User 140 may interact with application 120 via electronic device 110 and/or an attached device thereof.

In environment 100 of FIG. 1, if application 120 is in an active state, electronic device 110 may present interface 150 through application 120.

In some embodiments, electronic device 110 communicates with server 130 to enable the provision of services to application 120. The electronic device 110 may be any suitable type of mobile terminal, fixed terminal, or portable terminal, including a mobile phone, a desktop computer, a laptop computer, a notebook computer, a netbook computer, a tablet computer, a media computer, a multimedia tablet, a palmtop computer, a portable game terminal, a VR/AR device, and a Personal Communication System (PCS) device, personal navigation device, personal digital assistant (PDA), audio/video player, digital camera/camcorder, positioning device, television receiver, radio broadcast receiver, electronic book device, game device, or any combination of the foregoing, including accessories and peripherals for these devices, or any combination thereof. In some embodiments, electronic device 110 can also support any type of interface to a user (such as a ‘wearable’ circuit or the like).

The server 130 may be an independent physical server, may also be a server cluster or a distributed system formed by a plurality of physical servers, and may also be a cloud server that provides basic cloud computing services such as cloud services, cloud databases, cloud computing, cloud functions, cloud storage, network services, cloud communications, middleware services, domain name services, security services, content distribution networks, and big data and artificial intelligence platforms, etc. Server 130 may include, for example, a computing system/server, such as a mainframe, an edge computing node, a computing device in a cloud environment, etc. The server 130 may provide background services for the virtual scene-enabled application 120 in the electronic device 110.

A communication connection may be established between the server 130 and the electronic device 110. The communication connection may be established in a wired manner or a wireless manner. Communication connections may include, but are not limited to, Bluetooth connections, mobile network connections, Universal Serial Bus (USB) connections, Wireless Fidelity (WiFi) connections, and the like, to which embodiments of the present disclosure are not limited. In embodiments of the present disclosure, the server 130 and the electronic device 110 may enable signaling interaction through a communication connection therebetween.

It should be understood that the structure and function of the various elements in environment 100 are described for exemplary purposes only, and are not intended to imply any limitation on the scope of the disclosure.

Some example embodiments of the present disclosure will be described below with continued reference to the accompanying drawings.

### Example Application Creation Process

FIG. 2 illustrates a flowchart of an example request processing process 200 according to some embodiments of the disclosure. Process 200 can be implemented at the electronic device 110 and/or server 130. Process 200 is described below with reference to FIG. 1.

At block 210, a target request to be processed is received by a target application, the target application being associated with a plurality of processing entities.

In some embodiments, a developer may create, for example, a multi-processing entity based application. Such a processing entity may include, for example, an existing application (e.g., a bot program (bot)) or an agent.

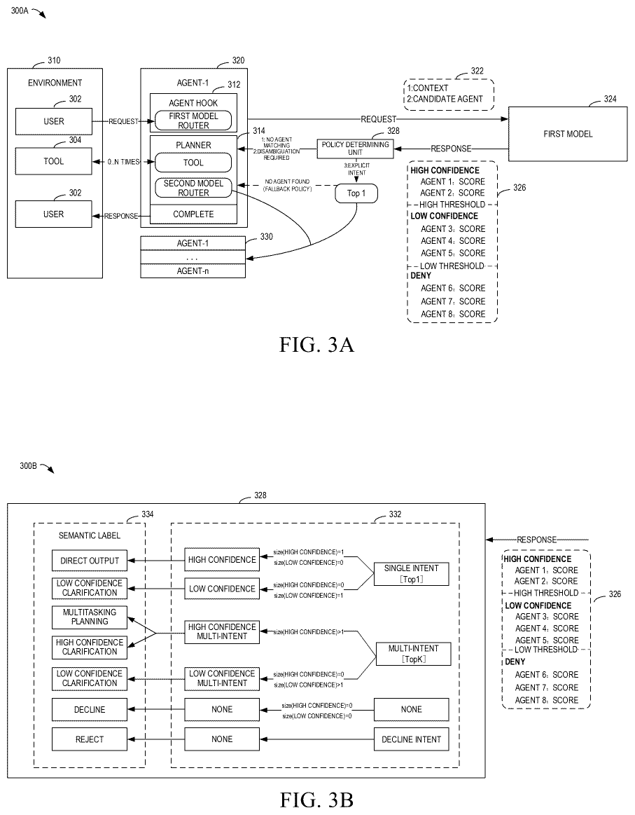

FIG. 3A illustrates an example framework of a processing request system 300A according to some embodiments of the disclosure. The processing system 300A describes a process of request processing with an agent as an application of a processing entity. It should be understood that the agent mentioned in the following embodiments may also be replaced with processing entities such as bots etc.

As an example, the application may receive a target request from a user 302 in the environment 310. As an example, the user 302 may send the target request through an interaction with a graphical interface provided by the target application. For example, the user 302 may send a query message via a session window provided by the target application.

At block 220, in response to the target request being provided to a first processing entity of the plurality of processing entities, evaluation information corresponding to the target request is generated using a first model, the evaluation information indicating a matching degree between the first set of processing entities associated with the first processing entity and the target request.

The agent 320 shown in FIG. 3A serves as an example of a first processing entity. As shown in FIG. 3A, the agent 320 may be configured with an agent hook 312 to utilize a first model 324 to determine a routing policy.

In some embodiments, the agent hook 312 may be triggered before the agent 320 processes the target request to determine whether to continue to process the request by the agent 320 or it is necessary to jump to other agents in the target application to process the request.

As shown in FIG. 3A, the agent 320 may initiate a request to the first model 324. Specifically, the input information 322 of the first model 324 may indicate a target request to be processed (e.g., a query message input by the user 302), context information, and a candidate agent.

In particular, such context information may include, for example, historical conversation information between the user 302 and the target application, etc. Such agents may include a set of associated agents associated with the agent 320, i.e., one or more other agents to which the agent 320 is allowed to jump. In some embodiments, the candidate agent may also include the agent 320 itself.

In some embodiments, the first model 324 may generate evaluation information 326 based on input information 322. The first model 324 may be implemented using an appropriate machine learning model. As an example, the first model 324 may, for example, have a relatively small model size and may have a relatively fast processing speed. For example, the first model 324 may be implemented as an intent classification model.

As shown in FIG. 3A, the evaluation information 326 may indicate a matching degree between one or more agents (i.e., the first set of processing entities) associated with the agent 320 and the request to be processed. Such matching degree may be represented, for example, by a confidence score to indicate the confidence of the intent corresponding to the different agents.

With continued reference to FIG. 2, at block 230, in response to the evaluation information satisfying a predetermined condition, a first jump policy associated with the first processing entity is determined using a second model.

With continued reference to FIG. 3A, the evaluation information 326 may further be provided, for example, to the policy determining unit 328. In some embodiments, the policy determining unit 328 may determine the jump policy based on the evaluation information 326 when the policy determining unit 328 determines that the evaluation information 328 does not satisfy the predetermined condition. For example, in a scenario where the policy determining unit 328 determines, based on evaluation information 326, that the target request corresponds to an explicit intent, the policy determining unit 328 may determine a jump policy of the agent 320 based on evaluation information 326.

In particular, the policy determining unit 328 may determine that the target request corresponds to a relatively explicit intent when the evaluation information 326 indicates that the number of agents having a matching degree greater than a first threshold value (e.g., a high threshold value) is less than a predetermined number. Further, the policy determining unit 328 may select an agent having a highest matching degree based on the evaluation information 326 to determine a jump policy of the agent 320.

For example, if the agent with the highest matching degree is the agent 320 itself, the target application may determine to continue to process the request by the agent 320. Conversely, if the agent with a highest matching degree is another agent, the target application may determine that it is necessary to jump to the highest matching agent to process the request.

Conversely, if the policy determining unit 328 determines that the evaluation information 326 satisfies the predetermined condition, the target application may further use the second model to determine a jump policy of the agent 320. As shown in FIG. 3A, if the policy determining unit 328 determines, based on the evaluation information 326, that there is no agent matching or an intent disambiguation is needed, the target application may utilize the planner 314 of the agent 320 to invoke the second model to determine the jump policy of the agent 320.

In some embodiments, the second model may, for example, be implemented based on an appropriate machine learning model. In contrast to the first model 324, the second model may, for example, have a relatively large model size and may handle more complex scenarios. For example, the second model may be implemented as a language model.

The specific determination process of the policy determining unit 328 will be described further below in connection with FIG. 3B. As shown in FIG. 3B, at processing stage 332, the policy determining unit 328 may divide the individual agents into a plurality of sets based on the matching degree of the individual agents indicated by the evaluation information 326. For example, the first set may include an agent with a matching degree greater than a high threshold value, and the second set may include an agent with a matching degree greater than a low threshold value and less than or equal to a high threshold value, and the third set may include an agent with a matching degree less than or equal to a low threshold value.

In some embodiments, the policy determining unit 328 may determine the number of agents in the first set. If the number is greater than a predetermined number, the policy determining unit 328 may determine that the evaluation information 326 satisfies a predetermined condition, and may trigger the second model to determine the jump policy. For example, if the number of agents in the first set is greater than one, the policy determining unit 328 may determine that intent ambiguity needs to be further eliminated.

As another example, if the first set does not include any agent, the policy determining unit 328 may determine that evaluation information 326 satisfies a predetermined condition, and may trigger the second model to determine a jump policy.

In some embodiments, the target application may initiate a request to the second model and may provide corresponding input information. Such input information may, for example, indicate a target request to be processed, an associated context, and one or more candidate agents (i.e., a second set of processing entities) associated with the agent 320.

In some embodiments, as with the candidate agent processed by the first model, the candidate agent to be processed by the second model may also include all the agents that the agent 320 can jump to.

However, in some scenarios, a target application may involve a large number of agents. An input of the second model may be constrained to not accept information of all candidate agents, or the second model may take a relatively long time to process a relatively large number of candidate agents.

In some embodiments, the candidate agents processed by the second model may be one or more associated agents determined based on the evaluation information 326. For example, the candidate agent indicated by the input information provided to the second model may include the agent in the first set and the second set determined based on the evaluation information 326, i.e., one or more agents having a matching degree greater than a low threshold.

In this way, the embodiments of the present disclosure may further reduce the complexity of the processing procedure of the second model, thereby improving the efficiency of determining the jump policy.

In some embodiments, in order to further improve the processing efficiency of the second model, if the number of the agents in the first set and the second set is greater than the predetermined number, the target application may further select the predetermined number of agents from the first set and the second set based on a matching degree. For example, the target application may select K agents with the highest matching degree based on the matching degree for processing by the second model.

On the contrary, if the number of the agents in the first set and the second set is less than or equal to the predetermined number, the target application provides all of the agents in the first set and the second set.

In some embodiments, to improve the processing efficiency of the second model, the target application may also generate description information regarding candidate agents provided to the second model based on the evaluation information 326. As an example, such description information may include a matching degree (e.g., a score) for each candidate agent. Alternatively, such description information may also include, for example, classification labels determined based on the matching degree. For example, the label of the candidate agent whose matching degree is greater than the high threshold may be ‘high confidence’, and the label of the candidate agent whose matching degree is greater than the low threshold and less than or equal to the high threshold may be ‘low confidence’.

By providing such description information, the second model may multiplex the output results of the first model, thereby improving the quality of the generated jump policy.

In some embodiments, the policy determining unit 328 may further determine from a set of predetermined scene labels, based on the matching degree indicated by the evaluation information 326, a target scene label which is also referred to as a semantic label, the target scene label being corresponding to the target request. As shown in FIG. 3B, at processing stage 334, the policy determining unit 328 may generate a corresponding semantic label, such a semantic label may be part of the input information of the second model to assist the second model in generating a jump policy.

In particular, as shown in FIG. 3B, the policy determining unit 328 may determine the corresponding semantic label based on the number of agents in the first set (i.e., the “high confidence” set) and the second set (i.e., the “low confidence” set) that correspond to different ranges of matching degrees.

For example, if size (high confidence)=1 and size (low confidence)=0, the policy determining unit 328 may generate a semantic label “direct output” to indicate that the target request corresponds to an explicit intent. Size (high confidence) represents the number of agents in the first set (i.e., the “high confidence” set), size (low confidence) represents the number of agents in the second set (i.e., the “low confidence” set).

For example, if size (high confidence)=0 and size (low confidence)=1, the policy determining unit 328 may generate a semantic label “Low confidence clarification” to indicate that the second model is needed to further determine whether the particular intent corresponding to the ‘low confidence’ set is accurate.

For example, if size (high confidence)>1, the policy determining unit 328 may generate a semantic label “multitasking planning” or “high confidence clarification” to indicate that the second model is needed to execute the jump policy of “multitasking planning”, or further determine the best matching intent in the ‘high confidence’ set in a single task scenario.

For example, if size (high confidence)=0 and size (low confidence)>1, the policy determining unit 328 may generate the semantic label “low confidence clarification” to indicate that the second model is needed to further determine if there is an intent matching in the ‘low confidence’ set.

For example, if size (high confidence)=0 and size (low confidence)=0, the policy determining unit 328 may generate a semantic label “decline” to indicate that no intent is recognized or no matching agent is found. Accordingly, the second model needs to determine whether the semantic label “reject” is accurate to determine whether the target application needs to execute a corresponding predetermined policy (e.g., a fallback policy).

For example, if the target request matches a decline intent configured by the agent 320 or the target application, the policy determining unit may also generate a semantic label “reject” to indicate that the target application or the agent 320 is not suitable to process the request. Accordingly, the second model needs to determine whether the semantic label “reject” is accurate to determine whether the target application needs to execute a corresponding predetermined policy (e.g., a fallback policy).

In some embodiments, the decline intent may be determined based on the developer's configuration information with respect to the target application or the agent 320. For example, the developer may express the type of the request that the target application or the agent does not respond to through a natural language.

Accordingly, the developer may also configure a predetermined policy (namely, a fallback policy) corresponding to the decline scenario. Such predetermined policy may include, for example, jumping to a predetermined agent, jumping to the manual processing, stopping at a current agent and replying with predetermined text, and so on.

With continued reference to FIG. 3A, the target application may accordingly determine a jump policy of the agent 320 based on an output result generated by the second model based on the input information. As an example, such an output result may indicate a particular agent 330 for processing the request.

Specifically, if that particular agent 330 is the agent 320 itself, the target application may determine not to perform the jump and stay at the agent 320 to process the request. Instead, the target application may determine to jump to a particular agent 330 to process the request.

In this manner, embodiments of the present disclosure can utilize a hybrid model (e.g., a model of various processing capabilities) to determine a jump policy for an in-application processing entity (e.g., a bot or an agent), thereby improving the processing efficiency of requests.

### Example Apparatus and Devices

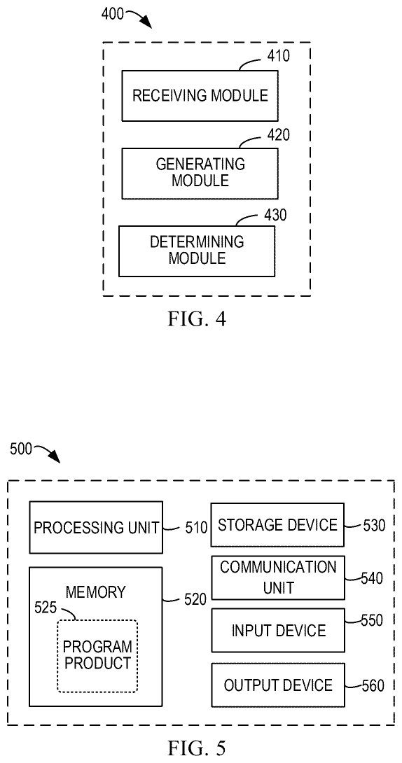

Embodiments of the present disclosure also provide corresponding apparatus for implementing the methods or processes described above. FIG. 4 illustrates a schematic structural block diagram of an example request processing apparatus 400 according to some embodiments of the present disclosure. The apparatus 400 may be implemented as or included in an electronic device 110 and/or a server 130. The various modules/components in the apparatus 400 may be implemented by hardware, software, firmware, or any combination thereof.

As shown in FIG. 4, an apparatus 400 comprises a receiving module 410 configured to receive a target request to be processed by a target application, the target application being associated with a plurality of processing entities; a generating module 420 configured to, in response to the target request being provided to a first processing entity of the plurality of processing entities, generate evaluation information corresponding to the target request using a first model, the evaluation information indicating a matching degree between the first set of processing entities associated with the first processing entity and the target request; and a determining module 430 configured to, in response to the evaluation information satisfying a predetermined condition, determine a first jump policy associated with the first processing entity using a second model.

In some embodiments, the determining module 430 is further configured to: determine whether the first set of processing entities comprise a target processing entity with a matching degree greater than a first threshold value; and in response to determining that i) the first set of processing entities fails to comprise the target processing entity or ii) a number of the target processing entities being greater than a first predetermined number, determine that the evaluation information satisfies the predetermined condition.

In some embodiments, the determining module 430 is further configured to: provide first input information to the second model, the first input information indicating the target request and a second set of processing entities associated with the first processing entity, the second set of processing entities being at least part of the processing entities of the first set of processing entities; and determining the first jump policy associated with the first processing entity based on output information of the second model.

In some embodiments, the determining module 430 is further configured to determine a third set of processing entities from the first set of processing entities, the matching degree of the third set of processing entities being greater than a second threshold value; and determine the second set of processing entities based on the third set of processing entities.

In some embodiments, the determining module 430 is further configured to in response to a number of the third set of processing entities being less than or equal to a second predetermined number, determine the third set of processing entities as the second set of processing entities; or in response to a number of the third set of processing entities being greater than a second predetermined number, determine the second set of processing entities from the third set of processing entities based on the matching degree, the second set of processing entities having the second predetermined number of processing entities.

In some embodiments, the first input information further comprises description information associated with the second set of processing entities, the description information being generated based on the evaluation information.

In some embodiments, the description information indicates: the matching degree corresponding to a respective processing entity of the second set of processing entities; or a classification label corresponding to a respective processing entity of the second set of processing entities, the classification label being determined based on the matching degree.

In some embodiments, the first input information further comprises a target scene label, the target scene label being determined from a set of predetermined scene labels based on the evaluation information.

In some embodiments, the apparatus 400 further comprises a dividing module configured to: divide the first set of processing entities into a plurality of sets corresponding to different ranges of matching degrees based on the matching degree indicated by the evaluation information; and determine the target scene label from the set of predetermined scene labels based on a number of processing entities in the plurality of sets.

In some embodiments, determining module 430 is further configured to: output a first message generated by the second model to a user; and determine, using the second model, the first jump policy based on a second message received from the user in response to the first message.

In some embodiments, the generating module 420 is further configured to: provide second input information to the first model, the second input information indicating the target request and a plurality of associated processing entities associated with the first processing entity; and obtain the evaluation information generated by the first model based on the second input information.

In some embodiments, the first jump policy indicates: responding, by the first processing entity, to the target request, or jumping to a second processing entity to respond to the target request.

In some embodiments, the determining module 430 is further configured to: in response to the evaluation information failing to satisfy the predetermined condition, determine a second jump policy associated with the first processing entity based on the matching degree.

In some embodiments, the determining module 430 is further configured to: determine a third processing entity from the first set of processing entities with a highest matching degree; and in response to the third processing entity being different from the first processing entity, determine to jump to the third processing entity to process the target request.

In some embodiments, the first model comprises a classification model, and the second model comprises a language model.

FIG. 5 illustrates a block diagram of an electronic device 500 in which one or more embodiments of the present disclosure may be implemented. It should be appreciated that the electronic device 500 shown in FIG. 5 is merely exemplary and should not constitute any limitation on the functionality and scope of the embodiments described herein. The electronic device 500 shown in FIG. 5 may be used to implement the electronic device 110 or the server 130 of FIG. 1.

As shown in FIG. 5, the electronic device 500 is in the form of a generic electronic device. The components of the electronic device 500 may include, but are not limited to, one or more processors or processing units 510, memory 520, storage device 530, one or more communication units 540, one or more input devices 550, and one or more output devices 560. The processing unit 510 may be a real or virtual processor and may be capable of performing various processes according to programs stored in the memory 520. In a multiprocessor system, a plurality of processing units execute computer executable instructions in parallel to improve the parallel processing capability of the electronic device 500.

The electronic device 500 typically includes a plurality of computer storage media. Such media may be any available media that is accessible to the electronic device 500, including, but not limited to, volatile and non-volatile media, removable and non-removable media. Memory 520 may be volatile memory (e.g., registers, cache, random access memory (RAM)), non-volatile memory (e.g., read-only memory (ROM), electrically erasable programmable read-only memory (EEPROM), flash memory), or some combination thereof. Storage device 530 may be a removable or non-removable medium and may include a machine-readable medium such as a flash drive, a magnetic disk, or any other medium that may be used to store information and/or data and that may be accessed within electronic device 500.

The electronic device 500 may further comprise additional removable/non-removable, volatile/nonvolatile storage media. Although not shown in FIG. 5, a magnetic disk drive for reading from or writing to a removable, nonvolatile magnetic disk such as a “floppy disk” and an optical disk drive for reading from or writing to a removable, nonvolatile optical disk may be provided. In these cases, each drive may be connected to a bus (not shown) by one or more data media interfaces. Memory 520 may include a computer program product 525 having one or more program modules configured to perform various methods or actions of various embodiments of the present disclosure.

The communication unit 540 implements communication with other electronic devices through a communication medium. In addition, functions of components of the electronic device 500 may be implemented by a single computing cluster or a plurality of computing machines, and these computing machines can communicate through a communication connection. Accordingly, the electronic device 500 may operate in a networked environment using logical connections to one or more other servers, network personal computers (PCs), or another network node.

Input device 550 may be one or more input devices such as a mouse, keyboard, trackball, etc. Output device 560 may be one or more output devices such as a display, speakers, printer, etc. The electronic device 500 may also communicate with one or more external devices (not shown), such as storage devices, display devices, etc., as needed through the communication unit 540, with one or more devices that enable a user to interact with the electronic device 500, or with any device (e.g., network card, modem, etc.) that enables the electronic device 500 to communicate with one or more other electronic devices. Such communication may be performed via an input/output (I/O) interface (not shown).

According to an exemplary implementation of the present disclosure, a computer-readable storage medium is provided, on which a computer-executable instruction is stored, wherein the computer-executable instruction is executed by a processor to implement the above-described method. According to an exemplary implementation of the present disclosure, there is also provided a computer program product, which is tangibly stored on a non-transitory computer-readable medium and includes computer-executable instructions that are executed by a processor to implement the method described above.

Aspects of the present disclosure are described herein with reference to flowchart illustrations and/or block diagrams of methods, apparatus, devices and computer program products implemented in accordance with the present disclosure. It should be understood that each block of the flowchart and/or block diagrams, and combinations of blocks in the flowchart and/or block diagrams, can be implemented by computer-readable program instructions.

These computer-readable program instructions may be provided to a processing unit of a general purpose computer, special purpose computer, or other programmable data processing apparatus to produce a machine, such that the instructions, which execute via the processing unit of the computer or other programmable data processing apparatus, create means for implementing the functions/actions specified in the flowchart and/or block diagram block or blocks. These computer-readable program instructions may also be stored in a computer-readable storage medium that can direct a computer, programmable data processing apparatus, and/or other devices to function in a particular manner, such that the computer-readable medium storing the instructions includes an article of manufacture including instructions which implement various aspects of the functions/actions specified in the flowchart and/or block diagram block or blocks.

The computer readable program instructions may be loaded onto a computer, other programmable data processing apparatus, or other devices, causing a series of operational steps to be performed on a computer, other programmable data processing apparatus, or other devices, to produce a computer implemented process such that the instructions which execute on the computer, other programmable data processing apparatus, or other devices implement the functions/actions specified in the flowchart and/or block diagram block or blocks.

The flowchart and block diagrams in the Figures illustrate the architecture, functionality, and operation of possible implementations of systems, methods and computer program products according to various implementations of the present disclosure. In this regard, each block in the flowchart or block diagrams may represent a module, segment, or portion of an instruction which comprises one or more executable instructions for implementing the specified logical function(s). In some alternative implementations, the functions noted in the blocks may occur out of the order noted in the figures. For example, two blocks shown in succession may, in fact, be executed substantially in parallel, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or actions, or combinations of special purpose hardware and computer instructions.

Having described implementations of the disclosure above, the foregoing description is exemplary, not exhaustive, and is not limited to the implementations disclosed. Many modifications and variations will be apparent to those of ordinary skill in the art without departing from the scope and spirit of the implementations described. The choice of terms used herein is intended to best explain the principles of the implementations, the practical application, or improvements to technologies in the marketplace, or to enable others of ordinary skill in the art to understand the implementations disclosed herein.

What is claimed is:

1. A request processing method, comprising:
receiving a target request to be processed by a target application, the target application being associated with a plurality of processing entities;
in response to the target request being provided to a first processing entity of the plurality of processing entities, generating evaluation information corresponding to the target request using a first model, the evaluation information indicating a matching degree between the first set of processing entities associated with the first processing entity and the target request; and
in response to the evaluation information satisfying a predetermined condition, determining a first jump policy associated with the first processing entity using a second model.

2. The method of claim 1, further comprising:
determining whether the first set of processing entities comprise a target processing entity with a matching degree greater than a first threshold value; and
in response to determining that i) the first set of processing entities fails to comprise the target processing entity with the matching degree greater than the first threshold value or ii) a number of the target processing entities is greater than a first predetermined number, determining that the evaluation information satisfies the predetermined condition.

3. The method according to claim 1, wherein in response to the evaluation information satisfying the predetermined condition, the determining the first jump policy associated with the first processing entity using the second model comprises:
providing first input information to the second model, the first input information indicating the target request and a second set of processing entities associated with the first processing entity, the second set of processing entities being at least part of the processing entities of the first set of processing entities; and
determining the first jump policy associated with the first processing entity based on output information of the second model.

4. The method of claim 3, further comprising:
determining a third set of processing entities from the first set of processing entities, the matching degree of the third set of processing entities being greater than a second threshold value; and
determining the second set of processing entities based on the third set of processing entities.

5. The method of claim 4, wherein determining the second set of processing entities based on the third set of processing entities comprises:
in response to a number of the third set of processing entities being less than or equal to a second predetermined number, determining the third set of processing entities as the second set of processing entities; or
in response to a number of the third set of processing entities being greater than a second predetermined number, determining the second set of processing entities from the third set of processing entities based on the matching degree, the second set of processing entities having the second predetermined number of processing entities.

6. The method of claim 3, wherein the first input information further comprises description information associated with the second set of processing entities, the description information being generated based on the evaluation information.

7. The method of claim 6, wherein the description information indicates:
the matching degree corresponding to a respective processing entity of the second set of processing entities; or
a classification label corresponding to a respective processing entity of the second set of processing entities, the classification label being determined based on the matching degree.

8. The method according to claim 3, wherein the first input information further comprises a target scene label, the target scene label being determined from a set of predetermined scene labels based on the evaluation information.

9. The method of claim 8, further comprising:
dividing the first set of processing entities into a plurality of sets corresponding to different ranges of matching degrees based on the matching degree indicated by the evaluation information; and
determining the target scene label from the set of predetermined scene labels based on a number of processing entities in the plurality of sets.

10. The method of claim 1, wherein in response to the evaluation information satisfying a predetermined condition, determining a first jump policy associated with the first processing entity using a second model comprises:
outputting a first message generated by the second model to a user; and
determining, using the second model, the first jump policy based on a second message received from the user in response to the first message.

11. The method of claim 1, wherein generating evaluation information corresponding to the target request with a first model comprises:
providing second input information to the first model, the second input information indicating the target request and a plurality of associated processing entities associated with the first processing entity; and
obtaining the evaluation information generated by the first model based on the second input information.

12. The method of claim 1, wherein the first jump policy indicates:
responding, by the first processing entity, to the target request, or
jumping to a second processing entity to respond to the target request.

13. The method of claim 1, further comprising:
in response to the evaluation information failing to satisfy the predetermined condition, determining a second jump policy associated with the first processing entity based on the matching degree.

14. The method of claim 13, wherein determining a second jump policy associated with the first processing entity based on the matching degree comprises:
determining a third processing entity from the first set of processing entities with a highest matching degree;
in response to the third processing entity being different from the first processing entity, determining to jump to the third processing entity to process the target request.

15. The method of claim 1, wherein the first model comprises a classification model, and the second model comprises a language model.

16. An electronic device, comprising:
at least one processing unit;
at least one memory coupled to the at least one processing unit and storing instructions for execution by the at least one processing unit that, when executed by the at least one processing unit, cause the electronic device to perform operations for request processing comprising:
receiving a target request to be processed by a target application, the target application being associated with a plurality of processing entities;
in response to the target request being provided to a first processing entity of the plurality of processing entities, generating evaluation information corresponding to the target request using a first model, the evaluation information indicating a matching degree between the first set of processing entities associated with the first processing entity and the target request; and
in response to the evaluation information satisfying a predetermined condition, determining a first jump policy associated with the first processing entity using a second model.

17. The electronic device of claim 16, wherein the operations further comprises:
determining whether the first set of processing entities comprise a target processing entity with a matching degree greater than a first threshold value; and
in response to determining that i) the first set of processing entities fails to comprise the target processing entity with the matching degree greater than the first threshold value or ii) a number of the target processing entities is greater than a first predetermined number, determining that the evaluation information satisfies the predetermined condition.

18. The electronic device of claim 16, wherein in response to the evaluation information satisfying the predetermined condition, the determining the first jump policy associated with the first processing entity using the second model comprises:
providing first input information to the second model, the first input information indicating the target request and a second set of processing entities associated with the first processing entity, the second set of processing entities being at least part of the processing entities of the first set of processing entities; and
determining the first jump policy associated with the first processing entity based on output information of the second model.

19. The electronic device of claim 18, wherein the method further comprises:
determining a third set of processing entities from the first set of processing entities, the matching degree of the third set of processing entities being greater than a second threshold value; and
determining the second set of processing entities based on the third set of processing entities.

20. A non-transitory computer readable storage medium, storing a computer program thereon, wherein the computer program is executable by a processor to cause the processor to perform operations comprising
receiving a target request to be processed by a target application, the target application being associated with a plurality of processing entities;
in response to the target request being provided to a first processing entity of the plurality of processing entities, generating evaluation information corresponding to the target request using a first model, the evaluation information indicating a matching degree between the first set of processing entities associated with the first processing entity and the target request; and
in response to the evaluation information satisfying a predetermined condition, determining a first jump policy associated with the first processing entity using a second model.
